(19) United States
(12) Patent Application Publication
(10) Pub. No.: US 2026/0237163 A1
(43) Pub. Date: Aug. 13, 2026

(54) ELECTRONIC DEVICE, METHOD, AND COMPUTER PROGRAM

(71) Applicant: Sony Semiconductor Solutions Corporation, Kanagawa (JP)

(72) Inventors: Stefan UHLICH, Baden-Württemberg (DE); Dunai FUENTES HITOS, Zurich (CH); Lev MARKHASIN, Stuttgart (DE); Justinas MISEIKIS, Stuttgart (DE); Diederik Paul MOEYS, Stuttgart (DE)

(73) Assignee: Sony Semiconductor Solutions Corporation, Kanagawa (JP)

(21) Appl. No.: 19/151,637

(22) PCT Filed: Feb. 21, 2024
(86) PCT No.: PCT/EP2024/054347

§ 371 Date: Jul. 29, 2025

(30) Foreign Application Priority Data
Feb. 22, 2023 (EP) 23158063.0

(51) Int. Cl. G06T 19/00; G06F 3/16; G06V 20/20

(52) U.S. Cl. CPC G06T 19/006; G06F 3/167; G06V 20/20

(57) ABSTRACT

An electronic device comprising circuitry configured to modify an Augmented Reality (AR) view and/or Virtual Reality (VR) view of a user based on a current audio data that the user is listening to.

### TECHNICAL FIELD

The present disclosure generally pertains to the field of audio processing, and in particular, to devices, methods and computer programs for AR-enhanced playback of music.

### TECHNICAL BACKGROUND

There is a lot of audio content available, for example, in the form of compact disks (CD), tapes, audio data files which can be downloaded from the internet, but also in the form of soundtracks of videos, e.g., stored on a digital video disk or the like, etc. Such an audio content may be used in an augmented reality (AR) scenario, also known as mixed reality.

It is known that augmented reality is an interactive experience combining the real world and a computer-generated content, such as a computer-generated image or video. For example, in AR there is a combination of real and virtual worlds, real-time interaction, and accurate three-dimensional (3D) registration of virtual and real objects. Augmented reality alters one's ongoing perception of a real-world environment.

Typically, in AR, the components of the digital world blend into a person's perception of the real world based on computer-generated content used to enhance natural environments or situations and offer perceptually enriched experiences.

However, there exist situations or applications in which by using AR technologies, the information about the real world of the user can be artificially altered when the information about the user environment and its objects are overlaid on the user real world.

Although there generally exist techniques for enriched augmented reality experiences, it is generally desirable to improve methods and apparatus for enriched augmented reality experiences.

### SUMMARY

According to a first aspect, the disclosure provides an electronic device comprising circuitry configured to modify an Augmented Reality (AR) view and/or Virtual Reality (VR) view of a user based on a current audio data that the user is listening to.

According to a second aspect, the disclosure provides a method comprising modifying an Augmented Reality (AR) view and/or Virtual Reality (VR) view of a user based on a current audio data that the user is listening to.

According to a third aspect, the disclosure provides a computer program comprising instructions, the instructions when executed on a processor causing the processor to modify an Augmented Reality (AR) view and/or Virtual Reality (VR) view of a user based on a current audio data that the user is listening to.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows a process for enhancing the music listening experience in augmented reality (AR) by modifying the objects detected in the AR view;

FIG. 2 shows in more detail an embodiment of the process of object detection performed in the process of enhancing the music listening experience described in FIG. 1;

FIG. 3 shows an embodiment of object information comprising an identified object, object location of the identified object and object pixel values of the identified object;

FIG. 4 schematically shows an embodiment of a process for performing audio event detection to obtain the audio source data and metadata;

FIG. 5 schematically shows a general approach of audio upmixing/remixing by means of blind source separation (BSS), such as music source separation (MSS);

FIG. 6 shows in more detail an embodiment of the process of prompt generation performed in the process of enhancing the music listening experience described in FIG. 1;

FIG. 7a schematically shows an embodiment of a process of generating a text prompt performed in the process of prompt generation performed in FIG. 6;

FIG. 7b schematically shows another embodiment of a process of generating a text prompt performed in the process of prompt generation performed in FIG. 6;

FIG. 8a schematically shows in more detail an embodiment of the process of conditioned image generation performed in the process of enhancing the music listening experience described in FIG. 1;

FIG. 8b schematically shows a process of stable diffusion used to perform conditioned image generation of a text-to-image/video model;

FIG. 9a schematically shows in more detail an embodiment of a process of conditioned image generation, wherein the text prompt indicates to replace the detected person with a person playing the guitar;

FIG. 9b schematically shows in more detail an embodiment of a process of conditioned image generation, wherein the text prompt indicates to replace text A with text B being the lyrics of the song the user is currently listening to;

FIG. 10 schematically shows a process of rendering image generation;

FIG. 11 shows a flow diagram visualizing a method for enhancing the music listening experience; and

FIG. 12 shows a block diagram depicting an embodiment of an electronic device that can implement the processes of enhancing a music listening experience in augmented reality (AR) by modifying the objects detected in the AR view.

### DETAILED DESCRIPTION OF EMBODIMENTS

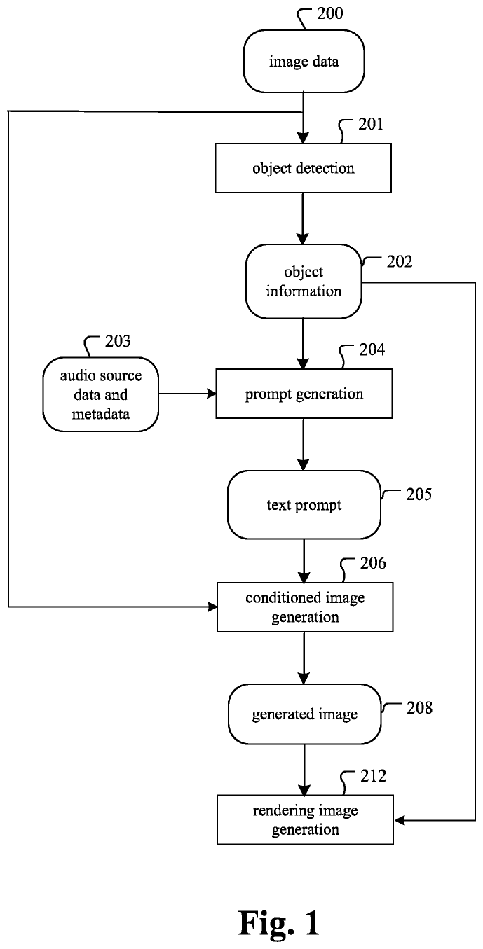

Before a detailed description of the embodiments under reference of FIG. 1 to 12 are given, general explanations are made.

As already described in the outset, a user may listen to audio data having a plurality of audio sources. Typically, the user is listening to music with headphones, wherein it is common to have an auditorial stimulus without having a change in the field of view of the user, for example, when the user is on the road or even at a concert.

In view of the above, it has been recognized that by adjusting the field of view of the listener according to the current music that is played and the environment the user is in may be used to enhance the music listening experience.

Thus, some embodiments pertain to an electronic device comprising circuitry configured to modify an Augmented Reality (AR) view and/or Virtual Reality (VR) view of a user based on a current audio data that the user is listening to.

The electronic device may be a digital (video) camera, an edge computing enabled image sensor, such as smart sensor associated with smart speaker, or the like, a smartphone, a personal computer, a laptop computer, a personal computer, a wearable electronic device, electronic glasses, professional music equipment or the like, a circuitry, a processor, multiple processors, logic circuits or a mixture of those parts. The wearable electronic device may for example be augmented reality glasses or virtual reality glasses. The AR glasses may be see-through glasses or may be non-see-through glasses. In this manner, the electronic device may for example enhance the music listening experience by adjusting the AR view of the listener according to the current music that is played and the environment the listener is in. The electronic device may be used e.g., when the user is at a concert as the stage might be far away as well as if someone is listening to music with headphones. In other words, the personal music listening experience from headphones may be enhanced by modifying the AR view conditioned on the music the user is listening to.

The electronic device may be implemented as or may comprise an AR music player configured to render the current audio data that the user is listening to. The audio data may be an audio file, an audio stream, an audio mixture or the like. The electronic device may be configured to acquire all the information related to the audio that the user is currently listening to. Thereby, the electronic device may be configured to modify the AR/VR view of the user based on the audio data that the user is currently listening to.

The circuitry may include one or more processors, logical circuits, memory (read only memory, random memory, etc., storage memory, i.e., hard disc, compact disc, flash drive, etc.), an interface for communication via a network, such as a wireless network, internet, local area network, or the like, a CMOS (Complementary Metal Oxide Semiconductor) image sensor, a CCD (Charge Coupled Device) image sensor, or the like.

In some embodiments, the Augmented Reality (AR) view and/or Virtual Reality (VR) view may be modified such that an identified object is replaced with a generated image or video.

In some embodiments, the current audio data that the user is listening to may be rendered by an Augmented Reality (AR) music player. For example, the electronic device may be implemented as or may comprise an AR music player configured to render the current audio data that the user is listening to. In this manner, the electronic device acquires all the information about the audio that the user is listening to, e.g., audio source data and metadata of the current audio data, and therefore, the electronic device is able to modify the AR/VR view of the user based on the audio data that the user is currently listening to.

In some embodiments, the generated image or video may be generated based on audio source data and metadata of the current audio data that the user is listening to. The audio source data and metadata of the current audio data that the user is listening to, are data acquired by an AR music player included in or implemented by the electronic device.

In some embodiments, the identified object may be a text and/or a person and wherein the generated image or video is lyrics and/or is the identified person playing a solo instrument.

In some embodiments, the Augmented Reality (AR) view and/or Virtual Reality (VR) view may be modified such that text is replaced with the lyrics.

In some embodiments, the Augmented Reality (AR) view and/or Virtual Reality (VR) view may be modified such that person is replaced with the identified person playing the solo instrument.

In some embodiments, modifying the Augmented Reality (AR) view and/or Virtual Reality (VR) view of the user may comprise rendering the generated image or video on an Augmented Reality (AR) and/or Virtual Reality (VR) device worn by the user. For example, rendering the generated image or video may be performed based on object information including bounding box information indicating which part of the image or video should be replaced by the generated image or video. The Augmented Reality (AR) and/or Virtual Reality (VR) device worn by the user may for example be augmented reality glasses or virtual reality glasses. The AR glasses may be see-through glasses or may be non-see-through glasses.

In some embodiments, modifying the Augmented Reality (AR) view and/or Virtual Reality (VR) view of the user may further comprise performing video object detection and/or image object detection to obtain object information related to the identified object. For example, performing video object detection may be performed by using a bounding box to acquire the identified object, object information and bounding box information.

Performing video object detection may include performing image object detection to obtain the identified object.

In some embodiments, modifying the Augmented Reality (AR) view and/or Virtual Reality (VR) view of the user may further comprise performing text prompt generation based on audio source data and metadata of the current audio data that the user is listening to and based on the object information to obtain text prompt.

In some embodiments, modifying the Augmented Reality (AR) view and/or Virtual Reality (VR) view of the user may further comprise performing conditioned image generation based on the text prompt and on image data related to the Augmented Reality (AR) view and/or Virtual Reality (VR) view of the user to obtain the generated image or video. Alternatively, the conditioned image generation may be performed on image data based on the text prompt and based on object information acquired by object detection to obtain the generated image or video.

The image data may be augmented reality (AR) data. For example, the image data may be still image or video images. The generated image may be a still image or video images. The generated image may for example be projected to the eyes of the user through augmented reality glasses.

Some embodiments pertain to an electronic device comprising circuitry configured to perform object detection on image data to identify an object and to provide object information related to the identified object, generate a text prompt based on the object information and based on audio source data and metadata and generate an image or video based on the text prompt.

The electronic device may be a digital (video) camera, an edge computing enabled image sensor, such as smart sensor associated with smart speaker, or the like, a smartphone, a personal computer, a laptop computer, a personal computer, a wearable electronic device, electronic glasses, professional music equipment or the like, a circuitry, a processor, multiple processors, logic circuits or a mixture of those parts.

The circuitry may include one or more processors, logical circuits, memory (read only memory, random memory, etc., storage memory, i.e., hard disc, compact disc, flash drive, etc.), an interface for communication via a network, such as a wireless network, internet, local area network, or the like, a CMOS (Complementary Metal Oxide Semiconductor) image sensor, a CCD (Charge Coupled Device) image sensor, or the like.

The image data may be augmented reality (AR) data. For example, the image data may be still image or video images. The generated image may be a still image or video images. The generated image may for example be projected to the eyes of the user through augmented reality glasses. The AR glasses may be see-through glasses or may be non-see-through glasses. In this manner, the electronic device may for example enhance the music listening experience by adjusting the AR view of the listener according to the current music that is played and the environment the listener is in. The electronic device may be used e.g., when the user is at a concert as the stage might be far away as well as if someone is listening to music with headphones. In other words, the personal music listening experience from headphones may be enhanced by modifying the AR view conditioned on the music the user is listening to.

Generating an image may include generating an image and/or generating a video.

In some embodiments, the object detection may comprise video object detection and/or image object detection.

In some embodiments, the object information may comprise the identified object, an object location of the identified object and object pixel values, without limiting the present disclosure in that regard. The identified object may be a person, a text, an object such as board, a table or the like, an animal, such as a pet and the like.

In some embodiments, the circuitry may be configured to perform conditioned image generation on image data based on the text prompt to obtain the generated image. The conditioned image generation may include conditioned image generation and/or conditioned video generation.

In some embodiments, the conditioned image generation may be implemented based on a transformer model.

In some embodiments, the transformer model may use a text-to-image conversion technology and/or text to video conversion technology implemented by encoder-decoder type of a neural network.

In some embodiments, the circuitry may be configured to perform audio event detection on audio data to obtain the audio source data and metadata. The audio data may be an audio file, and audio stream, an audio mixture or the like.

In some embodiments, the audio source data and metadata may comprise at least one of an audio source, an audio waveform, lyrics, beat information, song metadata, without limiting the present disclosure in that regard.

In some embodiments, the image data may comprise still images or video images.

In some embodiments, the circuitry may be configured to display the generated image or video to a user. The generated image or video may be rendered to the user into a virtual reality device, such as augmented reality glasses or the like. For example, the circuitry may superimpose the generated image or video on the identified object to adjust a field of view of a user according to the audio data that are rendered by the user's headphones earbuds and the like.

In some embodiments, the object detection may be implemented by a neural network.

In some embodiments, the neural network may be a convolutional neural network (CNN).

In some embodiments, performing audio event detection may include performing audio source separation.

Some embodiments pertain to a method comprising performing object detection on image data to identify an object and to provide object information related to the identified object, generating a text prompt based on the object information and based on audio source data and metadata and generating an image or video based on the text prompt.

Some embodiments pertain to a computer program comprising instructions, the instructions when executed on a processor causing the processor to perform object detection on image data to identify an object and to provide object information related to the identified object, generate a text prompt based on the object information and based on audio source data and metadata and generate an image or video based on the text prompt.

### Enhanced Music Listening Experience in Augmented Reality

FIG. 1 schematically shows a process for enhancing the music listening experience in augmented reality (AR) by modifying the objects detected in the AR view.

Image data 200 may comprise video and image data capturing the field of view of a user. An object detection 201 is performed on the image data 200 to obtain object information 202. A prompt generation 204 is performed based on the object information 202 and based on audio source data and metadata 203 to obtain text prompt 205, e.g., a replacement condition. A conditioned image generation 206 is performed on the image data 209 based on the text prompt 205 to generate an image 208. A rendering image generation 212 is performed on the generated image 208 based on the object information 202 to render the generated image 208 on a virtual reality device, e.g., worn by a user. For example, during the rendering image generation 212, the object information 202 may be used to replace those parts of the image/video where the object has been detected to make sure that the other parts are not modified.

In the embodiment of FIG. 1, the generated image 208 may be a still image or a video image and may be displayed or projected onto a virtual reality device, such as for example AR glasses that the user wears. In addition, the conditioned image generation 206 generates an image 208, without limiting the present embodiment in that regard. Alternatively, the conditioned image generation 206 generates a video. Moreover, the conditioned image generation 206 is performed on the image data 209 based on the text prompt 205 to generate an image and/or a video 208, without limiting the present embodiment in that regard. Alternatively, the conditioned image generation 206 may be performed on the image data 209 based on the text prompt 205 and the object information 202 to generate an image and/or a video 208. Furthermore, the object detection 201 and the conditioned image generation 206 may be implemented by a neural network, without limiting the present embodiment in that regard. For example, the object detection 201 may be implemented by a convolutional neural network (CNN) and the conditioned image generation 206 may be implemented by a text-to-image model neural network and/or text-to-video model neural network, without limiting the present embodiment in that regard.

In the embodiment of FIG. 1, for example, based on a song that a user is currently listening to, e.g., a rock song with a guitar solo, and a current AR field of view of the user, e.g., in a train with a person that is sitting opposite of the listener, an AR output is rendered, wherein the person that is sitting opposite of the user is playing the guitar solo on an electric guitar. Alternatively, a text in the AR field of view of the user may be replaced with the lyrics from the song in exactly the same style such that the lyrics are “embedded” into the field of view of the user. In this manner, the music listening experience of a user may be enhanced by adjusting the AR view of the user.

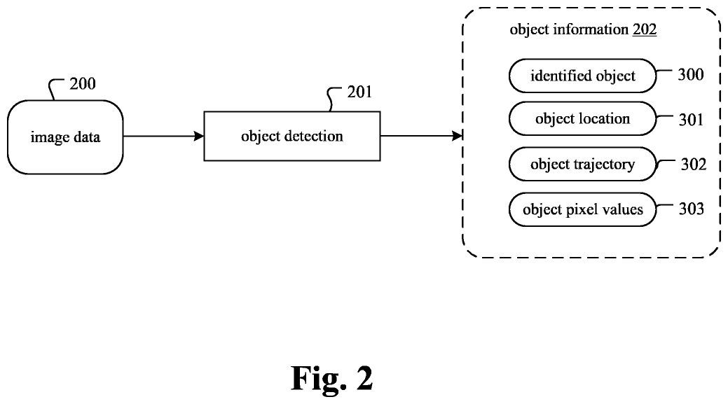

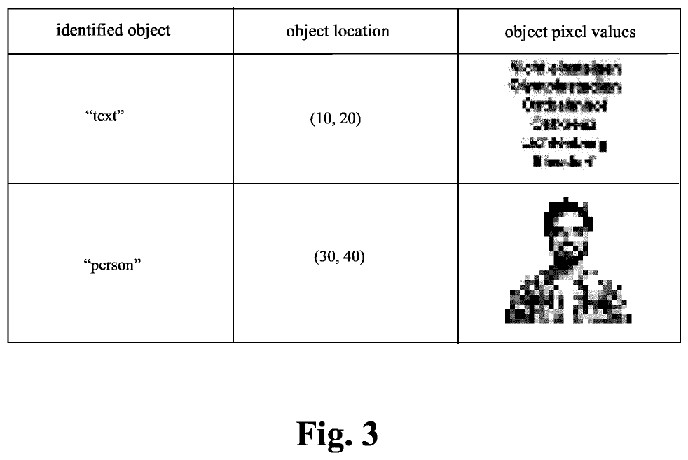

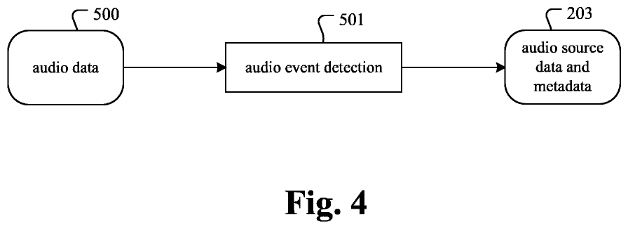

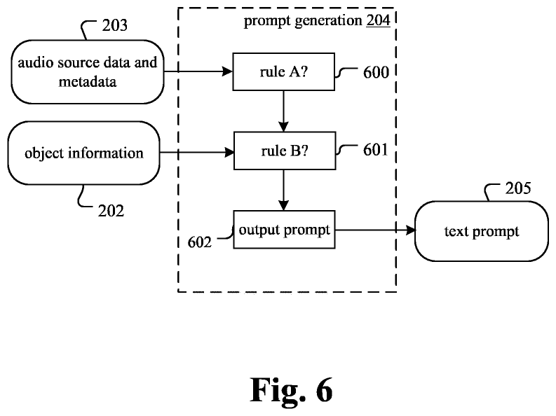

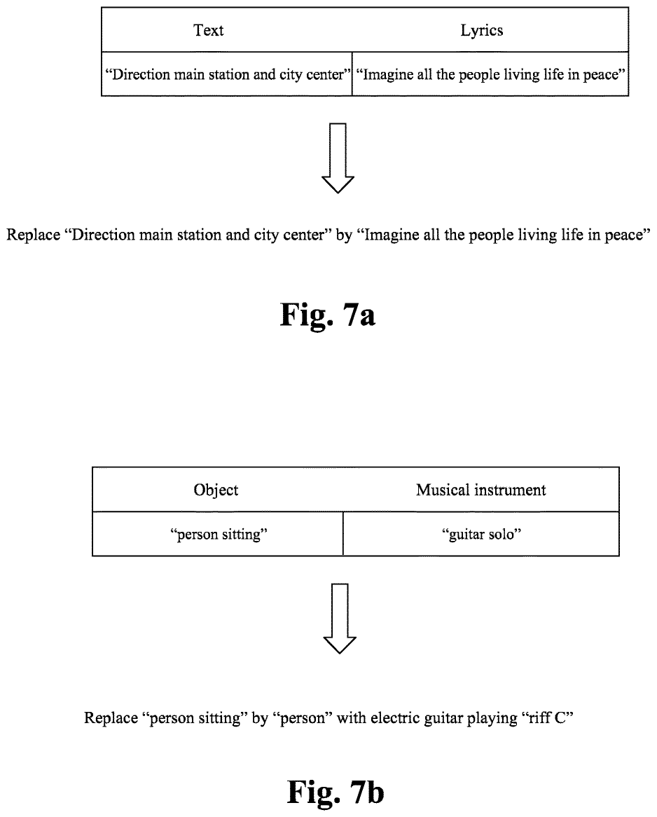

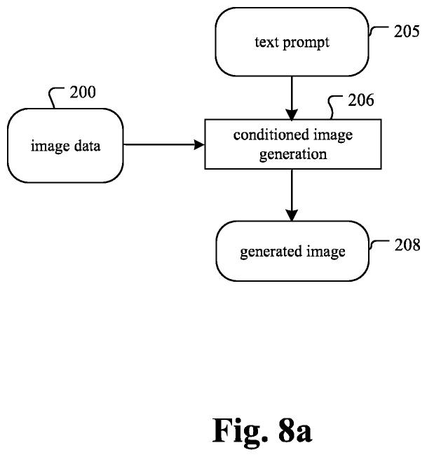

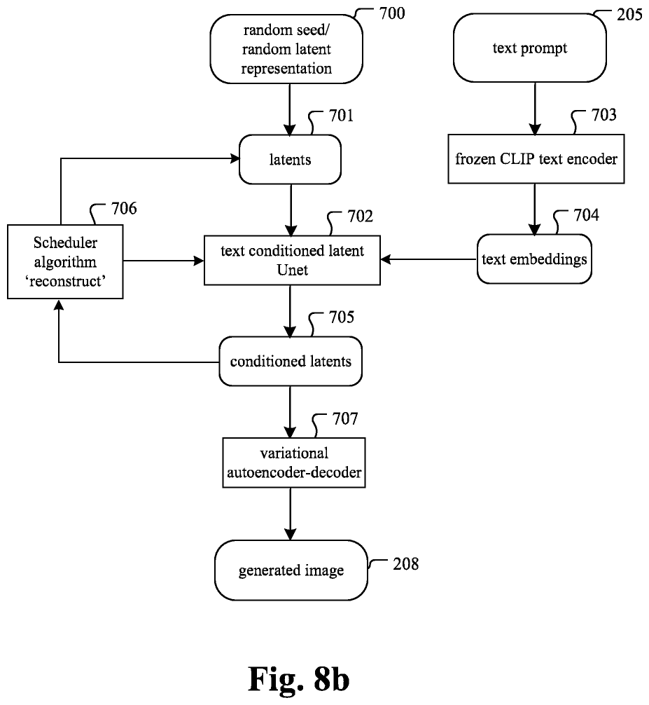

It should be noted that the object detection 201 is described in more detail in FIGS. 2 and 3 below. The audio source data and metadata 203 are obtained by performing audio event detection (see 501 in FIG. 4) on audio data (see 500 in FIG. 4). The prompt generation 204 is described in more detail in FIGS. 6 and 7 below. The conditioned image generation 206 is described in more detail in FIG. 8 below.

It should be further noted that besides adding and/or replacing objects, the size, location or color of the objects in the field of view of the user may be changed based on the loudness or on the beat of the music that the user is listening to.

### Object Detection

FIG. 2 shows in more detail an embodiment of the process of object detection performed in the process of enhancing the music listening experience described in FIG. 1.

The object detection 201 is performed on the image data 200 to obtain object information 202. The image data 200 are data capturing the field of view of a user, e.g., still images or video images. The object information 202 comprises for example, an identified object 300, object location 301 of the identified object 300, object trajectory 302 of the identified object 300, object pixel values 303 of the identified object 300, and the like. The object detection 201 analyzes any input video and/or image from e.g., AR glasses that the user wears, and detects objects which are interesting for replacement for example, persons, pets, other objects, or text in the current field of view of the user.

In the embodiment of FIG. 2, the object detection 201 may be implemented by a neural network, such as for example a standard convolutional neural network (CNN), as described by Kang, Kai, et al. in published paper “Object Detection from Video Tubelets with Convolutional Neural Networks” Proceedings of the IEEE conference on computer vision and pattern recognition. 2016 and by Joseph Redmon, et al. in published paper “You Only Look Once: Unified, Real-Time Object Detection”, arXiv:1506.02640.

As described in the published papers mentioned above, the object detection may be performed by using a bounding box that describes the spatial location of a target object. The bounding box is rectangular, and is determined for example, by the x and y coordinates of the upper-left corner of the rectangle and the coordinates of the lower-right corner. Alternatively, the bounding box may be represented by the (x, y)-axis coordinates of the bounding box center, and the width and height of the bounding box.

In other words, the bounding box is the region where the target object, e.g., the detected object, is present. For example, the bounding box, which is a rectangular box, contains the target object, here the identified object 300, or a set of points and it is superimposed over the target object including all important features and information of the target object residing in it.

In image processing, the bounding box typically refers to the border's coordinates that enclose the target object. The bounding box information is used to bind or identify the target object, e.g., an object to be detected, and serves as a reference point for object detection 201 and creates a collision box for that object, here the identified object 300. The bounding box coordinates carry information of where the target object, here the identified object 300, is located in the image. The object detection 201 may for example, be a combination of object classification and object localization.

The purpose of the bounding box is to reduce the range of search for the object features and thereby may conserve computing resources. It is used to classify the target objects and to perform object detection. The bounding box information is used for the rendering image generation (see 212 in FIG. 1).

In the embodiment of FIG. 2, the object detection 201 may detect the category of the detected object and a reliability factor indicating whether the detected category of the identified object is reliable or not.

FIG. 3 shows an embodiment of object information comprising an identified object, object location of the identified object and object pixel values of the identified object. For example, the object detection (see 201 in FIGS. 1 and 2) detects and identifies an object (see identified object 300 in FIG. 2), here a “text” and a “person”. Further, the object detection detects an object location, i.e., upper left and/or lower right coordinates of the identified object. For example, here the object location of the “text” is represented by the upper left coordinates of the identified object which are (10, 20), the object location of the “person” is represented by the upper left coordinates of the identified object which are (30, 40). Still further, the object detection detects object pixel values of the identified object. For example, here there is a symbolic representation of the pixel values in the form of a pixel map for the “text” and for the “person”.

In the embodiment of FIG. 3, the object location and object coordinates are included in the information provided by a bounding box used during the object detection (see 201 in FIGS. 1 and 2), as described in FIG. 2. The bounding box is rectangular, and is determined for example, by the x and y coordinates of the upper-left corner of the rectangle and the coordinates of the lower-right corner. Alternatively, the bounding box may be represented by the (x, y)-axis coordinates of the bounding box center, and the width and height of the bounding box. The bounding box is the region where the detected object is present, and this is the part that is replaced by the generated image (see 208 in FIG. 1).

In the embodiment of FIG. 3, the detected and identified objects are a “text” and a “person”, without limiting the present embodiment in that regard. Alternatively, an empty board or announcement table may be detected and identified as a suitable place to present to the user the song lyrics that he is currently listening to.

### Audio Event Detection

FIG. 4 schematically shows an embodiment of a process for performing audio event detection to obtain the audio source data and metadata.

An audio data 500 comprises a plurality of audio sources, for example, instruments, such as bass, drums, guitar, etc., vocals, or the like. An audio event detection 501 is performed on the audio data 500 to obtain audio source data and metadata 203. The audio event detection 501 detects what kind of instruments are in the mixture, whether for example, there is a guitar solo, drums, vocals or the like. The audio source data and metadata 203 may comprise information about the audio waveform and song metadata. For example, the audio source data and metadata 203 may comprise audio sources included in the audio, audio waveform of the audio sources, lyrics of the audio, beat information of the audio e and of the audio sources and other song metadata (e.g., song genre, release date, artist, album cover).

In the embodiment of FIG. 4, the audio data may be rendered by an Augmented Reality (AR) music player. The AR music player may be for example, configured to render the audio data that the user is currently listening to. In this manner, all the information related to the audio that the user is currently listening to, e.g., audio source data and metadata of the current audio data, are easily and accurately acquired, and therefore, the AR/VR view of the user may by modified based on the audio data that the user is currently listening to.

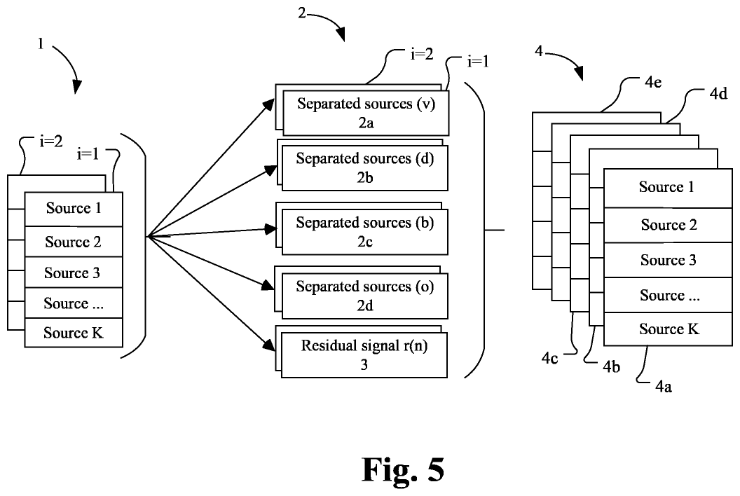

In the embodiment of FIG. 4, the audio event detection 501 may be performed for example, using source separation (see FIG. 5), without limiting the present embodiment in that regard. For example, the audio data may be an audio file, an audio stream or the like, i.e., comprising a rock song, wherein one of the audio sources may be a guitar solo. Alternatively, the audio data may be a blues song, one of the audio sources may be vocals of a singer singing a capella, without limiting the present embodiment in that regard. Still alternatively, the audio data may be a classical song, wherein one of the audio sources may be a violin solo, or a plurality of violins, without limiting the present embodiment in that regard. The audio data may be any kind of song and may comprise one or more audio sources of any kind.

### Audio Mixing by Means of Audio Source Separation

FIG. 5 schematically shows a general approach of audio upmixing/remixing by means of blind source separation (BSS), such as music source separation (MSS).

First, source separation (also called “demixing”) is performed which decomposes a source audio signal 1 comprising multiple channels Mᵢₙ and audio from multiple audio sources Source 1, Source 2, . . . , Source K (e.g. instruments, voice, etc.) into “separations”, here into source estimates 2a-2d for each channel i, wherein K is an integer number and denotes the number of audio sources. In the embodiment here, the source audio signal 1 is a stereo signal having two channels i=1 and i=2. As the separation of the audio source signal may be imperfect, for example, due to the mixing of the audio sources, a residual signal 3 (r(n)) is generated in addition to the separated audio source signals 2a-2d. The residual signal may for example represent a difference between the input audio content and the sum of all separated audio source signals. The audio signal emitted by each audio source is represented in the input audio content 1 by its respective recorded sound waves. For input audio content having more than one audio channel, such as stereo or surround sound input audio content, also a spatial information for the audio sources is typically included or represented by the input audio content, e.g. by the proportion of the audio source signal included in the different audio channels. The separation of the input audio content 1 into separated audio source signals 2a-2d and a residual 3 is performed on the basis of blind source separation or other techniques which are able to separate audio sources.

In a second step, the separations 2a-2d and the possible residual 3 are remixed and rendered to a new loudspeaker signal 4, here a signal comprising five channels 4a-4e, namely a 5.0 channel system. On the basis of the separated audio source signals and the residual signal, an output audio content is generated by mixing the separated audio source signals and the residual signal on the basis of spatial information. The output audio content is exemplary illustrated and denoted with reference number 4 in FIG. 5.

In the following, the number of audio channels of the input audio content is referred to as Mᵢₙ and the number of audio channels of the output audio content is referred to as Mₒᵤₜ. As the input audio content 1 in the example of FIG. 5 has two channels i=1 and i=2 and the output audio content 4 in the example of FIG. 5 has five channels 4a-4e, Mᵢₙ=2 and Mₒᵤₜ=5. The approach in FIG. 5 is generally referred to as remixing, and in particular as upmixing if Mᵢₙ<Mₒᵤₜ. In the example of the FIG. 5 the number of audio channels Mᵢₙ=2 of the input audio content 1 is smaller than the number of audio channels Mₒᵤₜ=5 of the output audio content 4, which is, thus, an upmixing from the stereo input audio content 1 to 5.0 surround sound output audio content 4. Technical details about source separation process described in FIG. 5 above are known to the skilled person. An exemplifying technique for performing blind source separation is for example disclosed in European patent application EP 3 201 917, or by Uhlich, Stefan, et al. “Improving music source separation based on deep neural networks through data augmentation and network blending.” 2017 IEEE International Conference on Acoustics, Speech and Signal Processing (ICASSP). IEEE, 2017. There also exist programming toolkits for performing blind source separation, such as Open-Unmix, DEMUCS, Spleeter, Asteroid, or the like which allow the skilled person to perform a source separation process as described in FIG. 1 above.

### Prompt Generation

FIG. 6 shows in more detail an embodiment of the process of prompt generation performed in the process of enhancing the music listening experience described in FIG. 1.

Audio source data and metadata 203 and object information 202 are input to the prompt generation 204 to obtain text prompt 205, such as for example, a replacement condition. In this embodiment, a rule-based prompt generation 204 is performed. The prompt generation 204 checks on the input audio source data and metadata 203 whether a rule A (first rule 600) is fulfilled, for example, whether the audio source contains vocals and we have access to the lyrics, is a solo instrument/has a dominant instrument, a plurality of instruments or the like. The prompt generation 204 checks on the identified object information 202 whether rule B (second rule 601) is fulfilled, for example, whether the identified object is a person, a board or a table or the like. If the first rule 600 and the second rule 601 are fulfilled, an output prompt signal 602 is generated and the prompt generation 204 outputs text prompts 205, such as for example, a replacement condition. Examples of the text prompt are given in more detail in FIGS. 7a and 7b below.

FIG. 7a schematically shows an embodiment of a process of generating a text prompt performed in the process of prompt generation performed in FIG. 6. The prompt generation (see 204 in FIGS. 2 and 6) allows to enhance the music listening experience of a user by adjusting the AR view of the user.

A user listens to a song with lyrics, here “Imagine all the people living life in peace” while being at a train station wherein within the field of view of the user there is a table with the text “Direction main station and city center”. The text prompt 205 is the “Replace “Direction main station and city center” by “Imagine all the people living life in peace””, which instructs the conditioned image generation (see 206 in FIGS. 2 and 8) to replace the text on the table at the train station with the current lyrics of the song that the user is listening to. That is the text in the field of view of the user may be replaced with the lyrics from the song in exactly the same style such that the lyrics are “embedded” into the field of view of the user.

In the embodiment of FIG. 7a, a table with a text is identified. Alternatively, the lyrics of the song may be “embedded” into the field of view of the user in any appropriate surface that is detected within the field of view of the user.

FIG. 7b schematically shows another embodiment of a process of generating a text prompt performed in the process of prompt generation performed in FIG. 6. The prompt generation (see 204 in FIGS. 1 and 6) allows to enhance the music listening experience of a user by adjusting the AR view of the user.

A user listens to a song with solo instrument, such as a rock song with solo guitar, while being at a train station wherein within the field of view of the user there is a person sitting opposite of the user in a train station. The text prompt 205 is the “Replace “person sitting” by “person” with electric guitar playing “riff C””, which instructs the conditioned image generation (see 206 in FIGS. 1 and 8) to replace the person sitting opposite of the user in the train station with the person playing the guitar solo on an electric guitar.

In the embodiment of FIG. 7b, the text prompt is “Replace “person sitting” by “person” with electric guitar playing “riff C””, without limiting the present embodiment in that regard. Alternatively, the text prompt may be “Generate a person with electric guitar playing “riff C””.

In the embodiment of FIG. 7a, a person sitting opposite of the user in a train station is identified. Alternatively, a singer signing the lyrics of the song may be detected and a person sitting opposite of the user in the train station may be identified, thereby the person sitting opposite of the user in the train station may be replaced with the same/new person singing-like a professional singer in a concert-the song that the user is currently listening to. Still alternatively, a pet, such as a cat or a dog may be detected and replaced with a pet, e.g., playing the guitar. Still alternatively, a person sitting opposite of the user in a train station and a table with or without a text may be identified within the field of view of the user, while the user is listening to a song with lyrics and instruments. The generated text prompt may instruct the conditioned image generation (see 206 in FIGS. 1 and 8) to replace the person sitting opposite of the user in the train station with the person playing the instrument that currently exists in the audio data and the current lyrics of the song that the user is listening to are replacing the text within the table or if there is no text, the lyrics are “embedded” e.g., onto the table into the field of view of the user. Still alternatively, if a plurality of people is detected, the generated text prompt may instruct the conditioned image generation (see 206 in FIGS. 1 and 8) to replace each one of the detected plurality of people to play a different instrument included in the song (audio data) that the user is currently listening to. Furthermore, it should be noted that the generated content might be a video such that the displayed objects in the AR view of the user are animated. For example, the lyrics that are shown have a marker which indicates which part currently is sung. Similarly, the replacement of a person with another/same person that plays a guitar is animated such that the user can watch him playing the current solo part.

It should be noted that the information indicating where to place the generated person, namely with which object to replace the generated person, may be included in the bounding box information acquired during the object detection. In the simplest case, only the replacement for the person may be created and render this replacement on e.g., the AR glasses, wherein everything that is inside the bounding box is replaced.

Finally, it should be noted that we can also replace images or advertisement posters in the AR view of the user with the album cover or adverts for a live concert of the band that the user currently is listening to.

### Conditioned Image Generation

FIG. 8 schematically shows in more detail an embodiment of the process of conditioned image generation performed in the process of enhancing the music listening experience described in FIG. 1.

Image data 200 acquired by capturing the field of view of the user are input to a conditioned image generation 206. Text prompt 205 described in more detail in FIGS. 6, 7a, 7b, are input to the conditioned image generation 206. The conditioned image generation 206, which is e.g. a conditioned text-to-image and/or text-to-video system, implemented by a neural network, uses the text prompt 205 to replace the object identified in the image data 200 with a modified version of it, here the generated image 208. The generated image 208, may be a still image or a video image, and includes for example the table that shows the lyrics of the song that the user listens to, the person playing the instrument solo, and/or the like.

This generated image is then projected or displayed onto the AR glasses that the user wears and thus is visible to the user. Here, the conditioned image generation 206 generates an image, without limiting the present embodiment in that regard. Alternatively, the conditioned image generation 206 may generate a video.

It should be noted that the conditioned image generation 206 may not only add and/or replace objects within the field of view of the user but may also change the size, location or color of objects in the field of view of the user based on the current loudness or on the beat of the song that the user is listening to.

In the embodiment of FIG. 8, the conditioned image generation 206 may be implemented by a neural network, such as a conditioned text-to-image and/or text-to-video system, namely a system using stable diffusion method, as described by Gal, Rinon, et al. in published paper “An image is worth one word: Personalizing text-to-image generation using textual inversion.” arXiv preprint arXiv:2208.01618 (2022), by Uriel Singer, et al. in published paper “Make-A-Video: Text-to-Video Generation without Text-Video Data”, arXiv:2209.14792 and by Ruben Villegas, et al. in published paper “Phenaki: Variable Length Video Generation From Open Domain Textual Description”, arXiv:2210.02399. In addition, the replacement of the sitting person with a person singing or playing a musical instrument solo may be also implemented as described by Fangzhou Hong, et al. in published paper “AvatarCLIP: Zero-Shot Text-Driven Generation and Animation of 3D Avatars”, arXiv:2205.08535.

FIG. 8b schematically shows a process of stable diffusion used to perform conditioned image generation of a text-to-image/video model.

Text-to-image models guide creation of an image through natural language text prompts. The conditioned text-to-image and/or text-to-video system, such as the conditioned image generation 206 can be implemented based on a transformer model.

A transformer model is a deep learning model that uses self-attention layers and is designed to process sequential input data, for example natural language texts to perform translation and text summarization. The transformer has an encoder-decoder architecture and gets as input text the text prompt 205. The encoder-decoder architecture comprises an encoder and a decoder. The encoder consists of encoding layers which process the input iteratively one layer after another. The decoder consists of decoding layers that process the encoder's output iteratively one layer after another.

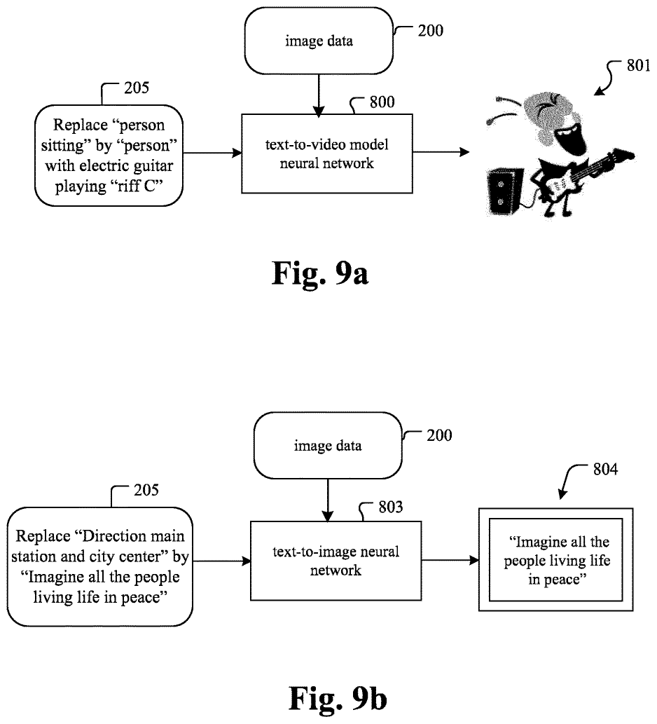

A text-to-image model is a machine learning model having two inputs: (1) a natural language description text, such as the text prompt 205 and (2) a random seed/random latent representation 700 or a latent representation of an image/a part of the current or the whole current AR view. The model outputs an image, such as generated image 208 or the images 801, 804 in FIGS. 9a, 9b, matching that description. Typically, text-to-image models use a language model and a generative image model. The language model, e.g., frozen CLIP text encoder 703, transforms the input text, e.g., the text prompt 205, into a latent representation, e.g., text embeddings 704. The generative image model, e.g., text conditioned latent Unit 705, produces an image conditioned on that representation, such as conditioned latent 705, or the images 801, 804 in FIGS. 9a, 9b. Using a suitable random latent representation or latent representation of an image/the current AR view 700 that is input to the text-to-image model 702, it is possible to render objects/persons that look like the original object/person but have the additional attribute that is described by the text prompt 205.

It should be noted that input 700 must not necessarily be a random seed or random latent representation. Alternatively, a latent representation of an image/a part of the current or the whole current AR view can be used as input. A VAE encoder may take any image to get its latent representation. This is useful e.g. for the case where one only wants to e.g. add a guitar to a person but would like to keep the other features fixed: Using a current AR view inside the bounding box, one can use the VAE encoder to obtain the latent representation of it. This may then be fed to the diffusion model together with the text embedding and by this, one can preserve many features as they were in the original image.

The text-to-image model is trained on large amounts of image data and text data sets. The text encoding step of the text-to-image model may be implemented by a recurrent neural network, such as a long short-term memory (LSTM) network. The image generation step of the text-to-image model may be implemented by conditional generative adversarial network or by a diffusion model.

Such a model may be trained to generate low-resolution images and may use one or more auxiliary deep learning models such as the VAE decoder in FIG. 8b and, optionally, an additional super-resolution model, to upscale the model, filling in finer details.

FIG. 9a schematically shows in more detail an embodiment of a process of conditioned image generation, wherein the text prompt indicates to replace the detected person with a person playing the guitar. A text-to-video model neural network neural network 800 receives as input the image data 200 and the text prompt 205, here “Replace “person sitting” by “person” with electric guitar playing “riff C””, indicating that the detected person should be replaced with a person playing the guitar. The text-to-video model neural network 800 output a person playing the guitar 801.

FIG. 9b schematically shows in more detail an embodiment of a process of conditioned image generation, wherein the text prompt indicates to replace text A with text B being the lyrics of the song the user is currently listening to. A text-to-image model neural network 803 receives as input the image data 200 and the text prompt 205, here “Replace “Direction main station and city center” by “Imagine all the people living life in peace”” and output a text 804 with the lyrics of the song the user is currently listening to, here “Imagine all the people living life in peace”.

In the embodiment of FIGS. 9a and 9b the text-to-image/video model neural network is an encoder-decoder neural network may be implemented as described by Gal, Rinon, et al. in the citation provided above.

It should, however, be noted that textual inversion is only one possible embodiment. In alternative embodiments, the model may also start the diffusion process from the latent representation of the image 200 itself. That is, a latent representation of an image/a part of the current or the whole current AR view can be used as input and a VAE encoder may take the image to get its latent representation. As described with regard to FIG. 8b above, using a current AR view inside the bounding box, one can use a VAE encoder to obtain the latent representation of it. This may then be fed to the diffusion model together with the text embedding.

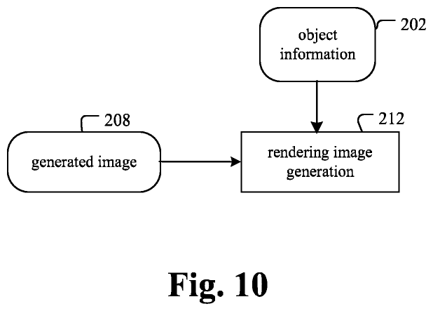

FIG. 10 schematically shows a process of rendering image generation, wherein the generated image is rendered in a virtual reality device worn by a user. A rendering image generation 212 receives as input a generated image 208 and object information 202 and renders the generated image 208 on a virtual reality device worn by a user. The object information 202 include bounding box information, namely information acquired during the object detection (see 201 in FIG. 1).

For example, the bounding box information comprises bounding box coordinates indicating where exactly the identified object (see 300 in FIG. 2), is located in the image. In this manner, during the rendering image generation 212, the object information 202 are used to replace those parts of the image/video where the identified object (see 300 in FIG. 2) has been detected to make sure that the other parts are not modified.

It should be noted that the virtual reality device, such as augmented reality (AR) glasses, may be a see-through device, wherein the generated image 208 is rendered by being displayed within the field of view of the user, e.g., by covering the detected identified object, without limiting the present embodiment in that regard. Alternatively, the virtual reality device may be a non-see-through device, wherein the generated image 208 is rendered by being superimposed or projected within the field of view of the user, e.g., by replacing the detected identified object.

### Method

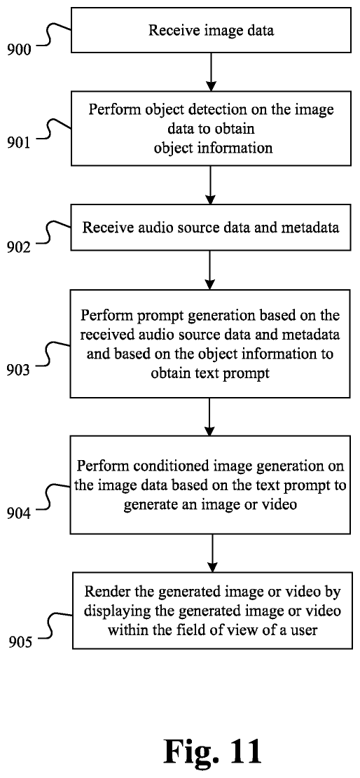

FIG. 11 shows a flow diagram visualizing a method for enhancing the music listening experience.

At 900, image data (see 200 in FIG. 1) are input to e.g., a neural network. At 901, object detection (see 201 in FIG. 1) is performed on the received image data to obtain object information (see 202 in FIG. 1). At 902, the prompt generation (see 204 in FIG. 1) receives audio source data and metadata (see 203 in FIG. 1). At 903, prompt generation (see 204 in FIG. 1) is performed based on the received audio source data and metadata and based on the object information to obtain text prompt (see 205 in FIG. 1). At 904, conditioned image generation (see 206 in FIG. 1) is performed on the image data based on the text prompt to generate an image or video (see 208 in FIG. 1). At 905, the generated image or video is render to a virtual reality device by displaying the generated image or video within the field of view of a user.

In this manner the music listening experience may be enhanced by adjusting the AR view of a user according to the music that is currently played and the environment that the user is in. Therefore, the immersion may be increased which may be useful for people in a concert as well as for a user who listens to music with his headphones.

### Implementation

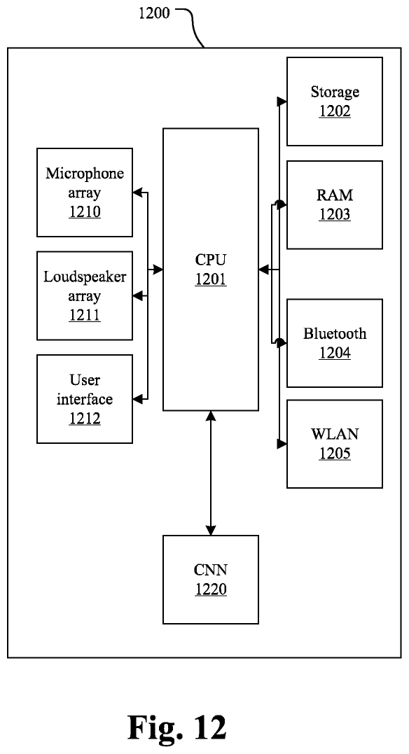

FIG. 12 shows a block diagram depicting an embodiment of an electronic device that can implement the processes of enhancing a music listening experience in augmented reality (AR) by modifying the objects detected in the AR view. The electronic device 1200 comprises a CPU 1201 as processor. The electronic device 1200 further comprises a microphone array 1210, a loudspeaker array 1211 and a convolutional neural network unit 1220 that are connected to the processor 1201. The CNN unit may for example be an artificial neural network in hardware, e.g., a neural network on GPUs or any other hardware specialized for the purpose of implementing an artificial neural network. Loudspeaker array 1211 consists of one or more loudspeakers that are distributed over a predefined space and is configured to render 3D audio. The electronic device 1200 further comprises a user interface 1212 that is connected to the processor 1201. This user interface 1212 acts as a man-machine interface and enables a dialogue between an administrator and the electronic system. The user interface 1212 may be a graphical user interface (GUI). Still further, an administrator may make configurations to the system using this user interface 1212. The electronic device 1200 further comprises a Bluetooth interface 1204, and a WLAN interface 1205. These units 1204, 1205 act as I/O interfaces for data communication with external devices. For example, additional loudspeakers, microphones, and video cameras with Ethernet, WLAN or Bluetooth connection may be coupled to the processor 1201 via these interfaces 1204, and 1205.

The electronic system 1200 further comprises a data storage 1202 and a data memory 1203 (here a RAM). The data memory 1203 is arranged to temporarily store or cache data or computer instructions for processing by the processor 1201. The data storage 1202 is arranged as a long-term storage, e.g., for recording sensor data obtained from the microphone array 1210 and provided to or retrieved from the CNN unit 1220. The data storage 1202 may also store audio data that represents audio messages, which the public announcement system may transport to people moving in the predefined space.

It should be noted that the description above is only an example configuration. Alternative configurations may be implemented with additional or other sensors, storage devices, interfaces, or the like.

It should be further noted that alternatively the electronic device 1200 may be implemented with a digital signal processor (DSP) or a graphics processing unit (GPU), without limiting the present disclosure in that regard.

It should also be noted that the division of the electronic device of FIG. 12 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

It should be recognized that the embodiments describe methods with an exemplary ordering of method steps. The specific ordering of method steps is, however, given for illustrative purposes only and should not be construed as binding.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An electronic device comprising circuitry configured to modify an Augmented Reality (AR) view and/or Virtual Reality (VR) view of a user based on a current audio data (500) that the user is listening to.
(2) The electronic device of (1), wherein the Augmented Reality (AR) view and/or Virtual Reality (VR) view is modified such that an identified object (300) is replaced with a generated image or video (208).
(3) The electronic device of (1) or (2), wherein the current audio data (500) that the user is listening to is rendered by an Augmented Reality (AR) music player.
(4) The electronic device of anyone of (1) to (3), wherein the generated image or video (208) is generated based on audio source data and metadata (203) of the current audio data (500) that the user is listening to.
(5) The electronic device of (2), wherein the identified object (300) is a text and/or a person and wherein the generated image or video (208) is lyrics and/or is the identified person playing a solo instrument.
(6) The electronic device of (5), wherein the Augmented Reality (AR) view and/or Virtual Reality (VR) view is modified such that text is replaced with the lyrics.
(7) The electronic device of (5), wherein the Augmented Reality (AR) view and/or Virtual Reality (VR) view is modified such that person is replaced with the with the identified person playing the solo instrument.
(8) The electronic device of (2), wherein modifying the Augmented Reality (AR) view and/or Virtual Reality (VR) view of the user comprises rendering (212) the generated image or video (208) on an Augmented Reality (AR) and/or Virtual Reality (VR) device worn by the user.
(9) The electronic device of (2), wherein modifying the Augmented Reality (AR) view and/or Virtual Reality (VR) view of the user further comprises performing video object detection and/or image object detection (201) to obtain object information (202) related to the identified object (300).
(10) The electronic device of (9), wherein modifying the Augmented Reality (AR) view and/or Virtual Reality (VR) view of the user further comprises performing text prompt generation (204) based on audio source data and metadata (203) of the current audio data (500) that the user is listening to and based on the object information (202) to obtain text prompt (205).
(11) The electronic device of (10), wherein modifying the Augmented Reality (AR) view and/or Virtual Reality (VR) view of the user further comprises performing conditioned image generation (206) based on the text prompt (205) and on image data (200) related to the Augmented Reality (AR) view and/or Virtual Reality (VR) view of the user to obtain the generated image or video (208).
(12) A method comprising
   modifying an Augmented Reality (AR) view and/or Virtual Reality (VR) view of a user based on a current audio data (500) that the user is listening to.
(13) A computer program comprising instructions, the instructions when executed on a processor causing the processor to perform the method of (12).
(14) An electronic device comprising circuitry configured to
   perform object detection (201) on image data (200) to identify an object (300) and to provide object information (202) related to the identified object (300);
   generate a text prompt (205) based on the object information (202) and based on audio source data and metadata (203); and
   generate an image or video (208) based on the text prompt (205).
(15) The electronic device of (14), wherein the object detection (201) comprises video object detection and/or image object detection.
(16) The electronic device of (14) or (15), wherein the object information (202) comprises the identified object (300), an object location (301) of the identified object (300) and object pixel values (303).
(17) The electronic device of anyone of (14) to (16), wherein the circuitry is configured to perform conditioned image generation (206) on image data (209) based on the text prompt (205) to obtain the generated image (208).
(18) The electronic device of (17), wherein the conditioned image generation (206) is implemented based on a transformer model.
(19) The electronic device of (18), wherein the transform model uses a text-to-image conversion technology and/or text to video conversion technology implemented by encoder-decoder type of neural network.
(20) The electronic device of anyone of (14) to (19), wherein the circuitry is configured to perform audio event detection (501) on audio data (500) to obtain the audio source data and metadata (203).
(21) The electronic device of anyone of (14) to (20), wherein the audio source data and metadata (203) comprise at least one of an audio source, an audio waveform, lyrics, beat information, song metadata.
(22) The electronic device of anyone of (14) to (21), wherein the image data (200) comprise still images or video images.
(23) The electronic device of anyone of (14) to (22), wherein the circuitry is configured to display the generated image or video (208) to a user.
(24) The electronic device of (23), wherein performing audio event detection (501) includes performing audio source separation.
(25) The electronic device of anyone of (14) to (24), wherein the object detection (201) is implemented by a neural network.
(26) The electronic device of (25), wherein the neural network is a convolutional neural network (CNN).
(27) A method comprising
   performing object detection (201) on image data (200) to identify an object (300) and to provide object information (202) related to the identified object (300);
   generating a text prompt (205) based on the object information (202) and based on audio source data and metadata (203); and
   generating an image or video (208) based on the text prompt (205).
(28) A computer program comprising instructions, the instructions when executed on a processor causing the processor to perform the method of (27).

1. An electronic device comprising circuitry configured to
modify an Augmented Reality view and/or Virtual Reality view of a user based on a current audio data that the user is listening to.

2. The electronic device of claim 1, wherein the Augmented Reality view and/or Virtual Reality view is modified such that an identified object is replaced with a generated image or video.

3. The electronic device of claim 1, wherein the current audio data that the user is listening to is rendered by an Augmented Reality music player.

4. The electronic device of claim 2, wherein the generated image or video is generated based on audio source data and metadata of the current audio data that the user is listening to.

5. The electronic device of claim 2, wherein the identified object is a text and/or a person and wherein the generated image or video is lyrics and/or is the identified person playing a solo instrument.

6. The electronic device of claim 5, wherein the Augmented Reality view and/or Virtual Reality view is modified such that text is replaced with the lyrics.

7. The electronic device of claim 5, wherein the Augmented Reality view and/or Virtual Reality view is modified such that person is replaced with the with the identified person playing the solo instrument.

8. The electronic device of claim 2, wherein modifying the Augmented Reality view and/or Virtual Reality view of the user comprises rendering the generated image or video on an Augmented Reality and/or Virtual Reality device worn by the user.

9. The electronic device of claim 2, wherein modifying the Augmented Reality view and/or Virtual Reality view of the user further comprises performing video object detection and/or image object detection to obtain object information related to the identified object.

10. The electronic device of claim 9, wherein modifying the Augmented Reality view and/or Virtual Reality view of the user further comprises performing text prompt generation based on audio source data and metadata of the current audio data that the user is listening to and based on the object information to obtain text prompt.

11. The electronic device of claim 10, wherein modifying the Augmented Reality view and/or Virtual Reality view of the user further comprises performing conditioned image generation based on the text prompt and on image data related to the Augmented Reality view and/or Virtual Reality view of the user to obtain the generated image or video.

12. A method comprising
modifying an Augmented Reality view and/or Virtual Reality view of a user based on a current audio data that the user is listening to.

13. A computer program comprising instructions, the instructions when executed on a processor causing the processor to perform the method of claim 12.

14. An electronic device comprising circuitry configured to
perform object detection on image data to identify an object and to provide object information related to the identified object;
generate a text prompt based on the object information and based on audio source data and metadata; and
generate an image or video based on the text prompt.

15. The electronic device of claim 14, wherein the object detection comprises video object detection and/or image object detection.

16. The electronic device of claim 14, wherein the circuitry is configured to perform conditioned image generation on image data based on the text prompt to obtain the generated image.

17. The electronic device of claim 14, wherein the circuitry is configured to perform audio event detection on audio data to obtain the audio source data and metadata.

18. A method comprising
performing object detection on image data to identify an object and to provide object information related to the identified object;
generating a text prompt based on the object information and based on audio source data and metadata; and
generating an image or video based on the text prompt.

19. A computer program comprising instructions, the instructions when executed on a processor causing the processor to perform the method of claim 18.
